(19) United States
(12) Patent Application Publication
(10) Pub. No.: US 2026/0272088 A1
(43) Pub. Date: Sep. 17, 2026

(54) COMPOSITE PERMANENT MAGNET MATERIAL AND MAGNET-FREE MAGNETIC FALSE EYELASH

(71) Applicant: Qingdao Yiernuo Arts and Crafts Import & Export Co., Ltd., Qingdao, Shandong (CN)

(72) Inventors: Fengmei Xu, Qingdao, Shandong (CN); Xinyi Li, Qingdao, Shandong (CN)

(21) Appl. No.: 19/092,431

(22) Filed: Mar. 27, 2025

(30) Foreign Application Priority Data
Mar. 13, 2025 (CN) 2025102987181

(51) Int. Cl. A41G 5/02; H01F 1/03; H01F 1/057

(52) U.S. Cl. CPC A41G 5/02; H01F 1/0315; H01F 1/0578

(57) ABSTRACT

The composite permanent magnet material exhibits favorable magnetism, and the magnet-free magnetic false eyelashes made from the material enhance comfort and simplicity of wearing for female users while ensuring magnetic adhesion functions. The present disclosure overcomes the defect of manually adding magnetic blocks in traditional magnetic eyelashes to achieve magnetic attraction, and enhances the softness of the false eyelash bands while effectively controlling costs, and significantly enhancing wearing comfort and user experience. The present disclosure meets market demands for innovative and safe cosmetic products, and has promising market prospects.

### TECHNICAL FIELD

The present disclosure relates to the technical field of flexible magnetic materials, and in particular to a composite permanent magnet material and a magnet-free magnetic false eyelash.

### BACKGROUND

False eyelashes are artificial eyelashes used to beautify eyes by lengthening and thickening the natural eyelashes, which make the eyes look larger, brighter, fuller, and more expressive. In recent years, magnetic false eyelashes have emerged to meet market demands and user preferences for ease of use.

As stated in the background art of the Chinese patent CN116250665A, magnetic false eyelashes of the prior art mainly fall into two categories: strip eyelashes, which are worn mainly by combining magnetic elements containing hard magnetic blocks with magnetic liquid eyeliners; and soft magnetic eyelashes, which are in magnetic attraction connection with upper sides of natural eyelashes through upper and lower hard magnetic blocks. However, when the magnetic liquid eyeliners are used, the hard magnetic blocks increase weights of eyelashes, and the hard magnetic blocks cause discomfort of wearing due to direct contact with skin of a user. Moreover, use of the liquid eyeliners imposes higher requirements for makeup techniques of the user. Additionally, makeup removal is required after use, and a process of use is complicated. Further, exposure of magnetic liquid to the skin increases the risk of allergies. Therefore, dual-layer magnetic eyelashes that are worn through magnetic attraction of upper and lower eyelash strips, have received wider attention and been applied to a wider range. However, the dual-layer magnetic eyelashes with the upper and lower hard magnetic blocks of the prior art have the following defects: 1) magnetic eyelashes with the hard magnetic blocks have strong magnetism but the magnetic blocks are prone to detachment and might seriously damage natural eyelashes due to weights; and 2) the soft magnetic eyelashes with fragile magnetic blocks have the defects of poor magnetism and low production but high manufacturing costs, thereby being unacceptable for many women.

The Chinese patent CN116250665A further provides a double-layer magnetic eyelash ornament. The double-layer magnetic eyelash ornament includes a primary eyelash strip and a secondary eyelash strip, where the primary eyelash strip is provided with a rigid magnet unit, and the secondary eyelash strip is provided with a flexible magnetic conductive sheet. Magnetic attraction between the rigid magnet unit and the flexible magnetic conductive sheet achieves the purpose of improving the effect and comfort of wearing the double-layer magnetic eyelash ornament. According to the technical solution disclosed in this patent, the double-layer magnetic eyelash ornament of the prior art is generally worn by means of magnetic attraction through the rigid magnetic unit. In a machining process, the rigid magnetic unit is connected to a false eyelash body by means of adhesive bonding. The convenience of using such magnetic eyelashes mainly depends on the size and quantity of the rigid magnetic units. For example,
when the rigid magnetic unit is too large, a large weight thereof may lead to damage or detachment of eyelashes, while the rigid magnetic unit of a small size enhances comfort, but increase the complexity and costs of production are high. Additionally, a small contact area and weak attraction of the rigid magnetic unit easily cause detachment during wearing.

At present, known magnetic false eyelashes usually contain a plurality of rigid magnetic units, and a magnetic contact area is enlarged during wearing by increasing the rigid magnetic units. However, weights and dense distribution of the rigid magnetic units compromise original softness of false eyelash bands made of cotton. Furthermore, to prevent false eyelashes from detachment during wearing, the magnetic false eyelashes can only be thinner, thereby significantly limiting user options.

Therefore, there is an urgent need to solve the above technical problems and provide a magnet-free magnetic false eyelash that is more comfortable and safer to wear.

### SUMMARY

In order to solve the above technical problems, an objective of the present disclosure is to provide a composite permanent magnet material and a magnet-free magnetic false eyelash containing same. The composite permanent magnet material has favorable magnetism, which is cost-effective and is easy to process. Furthermore, the present disclosure further provides a magnet-free magnetic false eyelash made from the composite permanent magnet material. The composite permanent magnet material exhibits strong magnetism and has magnetic adhesion functions, such that the magnet-free magnetic false eyelashes made from the material enhance comfort and simplicity of wearing for female users. The present disclosure overcomes the defect of manually adding magnetic blocks in traditional magnetic eyelashes to achieve magnetic attraction, and enhances the softness of the false eyelash bands while effectively controlling costs, and significantly enhancing wearing comfort and user experience. The present disclosure meets market demands for innovative and safe cosmetic products, and has promising market prospects.

To achieve the above technical effects, the present disclosure adopts the following technical solutions:

In a first aspect, the present disclosure provides a composite permanent magnet material, and the composite permanent magnet material includes the following raw materials in parts by mass: 15-25 parts of pre-modified ferrite magnetic powder, 50-75 parts of neodymium-iron-boron (NdFeB) magnetic powder, 1-5 parts of a coupling agent, 8-12 parts of a resin matrix, 3-5 parts of a filling agent, 0.1-0.5 part of a curing agent, and 0.8-1.4 parts of a lubricant.

Preferably, the coupling agent is any one of a silane coupling agent or a titanate coupling agent, where the silane coupling agent is any one or a combination of KH550 and KH560, and the titanate coupling agent is any one or a combination of NDZ-101 and NDZ-201;
preferably, the filling agent is selected from any one or more of silica powder, silicon nitride powder, aluminum silicate powder, calcium silicate powder, calcium carbonate powder, and barium sulfate powder;
preferably, the curing agent is any one or a combination of benzoyl peroxide and dibutyltin dilaurate; and
preferably, the lubricant is any one or more of magnesium stearate, zinc stearate, stearic acid, or paraffin.

Further, the resin matrix is a mixture of any one or more of styrene-butadiene rubber (SBR), a thermoplastic polyurethane elastomer (TPU), a styrene-butadiene-styrene (SBS) block copolymer, and epoxy resin.

In a second aspect, the present disclosure further provides a preparation method for the composite permanent magnet material, and the method includes the following steps:
S1: modifying ferrite magnetic powder as a raw material to prepare pre-modified ferrite magnetic powder; and mixing the pre-modified ferrite magnetic powder evenly with NdFeB magnetic powder to obtain mixed magnetic powder;
S2: slowly adding a coupling agent to the mixed magnetic powder while starting a high-speed mixer, and stirring at a speed of 300-500 rpm for 1-2 h to ensure the coupling agent is uniformly coated on surfaces of particles of the mixed magnetic powder;
S3: pouring a resin matrix into the high-speed mixer while stirring at a low speed and adding the mixed magnetic powder coated with the coupling agent to the resin matrix, adding a curing agent, and stirring at a speed of 300-800 rpm to obtain a mixed system; and
S4: moving the mixed system to an ultrasonic disperser for ultrasound dispersion treatment for 10-50 min to prepare a magnetic colloid.

Further, the preparation method for the composite permanent magnet material further includes the step of curing the obtained magnetic colloid.

Preferably, the preparation method for the composite permanent magnet material further includes the step of thermocuring or photocuring the obtained magnetic colloid.

Further, in the S1, a preparation method for the pre-modified ferrite magnetic powder includes:
calcining ferrite magnetic powder at 1000-1100° C. for 4-6 h, cooling same to room temperature, then grinding the ferrite magnetic powder with a ball mill for 6-8 h, and modifying same with a chemical modification solution, where the chemical modification solution includes at least an alkyl coupling agent; and
preferably, the chemical modification solution includes the following raw materials in parts by mass: 0.5-2 parts of sodium dodecylbenzenesulfonate, 2-5 parts of aluminum nitrate, 1-3 parts of zinc nitrate, 2-6 parts of polyvinyl alcohol, 2-4 parts of polymethyl methacrylate, 2-5 parts of a silane coupling agent, and 70-80 parts of water.

In a third aspect, the present disclosure further provides an application of the composite permanent magnet material in cosmetics and beauty products, particularly in wearable cosmetics and beauty products.

In a fourth aspect, the present disclosure specifically provides a magnet-free magnetic false eyelash, and the magnet-free magnetic false eyelash includes at least one magnetic-inductive component and a simulated hair portion attached to the magnetic-inductive component, where the magnetic-inductive component is partially or entirely made from the composite permanent magnet material provided in the first aspect.

Preferably, the magnet-free magnetic false eyelash includes an upper simulated eyelash strip and a lower simulated eyelash strip, the upper simulated eyelash strip and the lower simulated eyelash strip either includes a lash band and a simulated hair portion attached thereto, where the lash band is partially or entirely made from the composite permanent magnet material provided in the first aspect.

Compared with the prior art, the present disclosure has the following beneficial effects:

Firstly, the composite permanent magnet material provided by the present disclosure combines the pre-modified ferrite magnetic powder with NdFeB magnetic powder, and a small amount of pre-modified ferrite is added to the system to provide a certain magnetic foundation; and a small amount of 3000-mesh NdFeB magnetic powder is added to enhance overall magnetic performance on the basis of achieving a balance in cost and performance. During processing of the ferrite magnetic powder, calcination perfects a crystal structure of the ferrite magnetic powder and enhances magnetic performance; a particle size is controlled through ball milling, which facilitates subsequent dispersion and mixing; and a chemical solution, particularly a specific formula solution, is used for modifying, which further optimizes surface properties and enhances compatibility with other components, such that a magnetic colloid prepared features good uniformity and stability.

Further, the present disclosure provides a magnet-free magnetic false eyelash, and the magnet-free magnetic false eyelash is at least partially or entirely made from the composite permanent magnet material provided in the first aspect. Compared to the traditional processing method of manually adding hard magnetic blocks, the processing method of the present disclosure with the composite permanent magnet material is simple and feasible. The magnetic adhesion functions of the magnet-free magnetic false eyelashes are ensured on the basis of cost control. Additionally, due to good stability and uniformity of the composite permanent magnet material, magnetic and mechanical properties of false eyelashes remain consistent during subsequent processing, and the softness of the eyelash band is enhanced, thereby greatly enhancing comfort of wearing, and ensuring strong magnetic attraction without easy detachment.

Finally, compared to traditional adhesive-bonded false eyelashes and hard magnetic false eyelashes, the magnet-free magnetic false eyelashes provided by the present disclosure, where the composite permanent magnet material is used in the eyelash bands, are more convenient, hygienic, and reusable, thereby reducing irritation to the eyes from glue, and enhancing user experience and wearing comfort due to softness. The present disclose meets market demands for innovative and safe cosmetic products, and has promising market prospects.

### DETAILED DESCRIPTIONS OF THE EMBODIMENTS

The following examples are merely used to more clearly describe the technical solutions of the present disclosure, and therefore are only exemplary, instead of limiting the scope of protection of the present disclosure. The specific examples listed in the present disclosure are merely exemplars thereof, and the present disclosure is not limited to the specific examples described below. For those skilled in the art, any equivalent modifications and substitutions made to the examples described below also fall within the scope of the present disclosure. Therefore, any equivalent transformations and modifications made without departing from the spirit and scope of the present disclosure should fall within the scope of the present disclosure. To better illustrate the present disclosure, many specific details are disclosed in the following specific embodiments. Those skilled in the art should understand that the present disclosure can also be implemented without some specific details. In some other examples, methods, means, equipment and steps well known to those skilled in the art are not described herein in detail to highlight the key inventive concepts of the present disclosure.

Unless otherwise defined, all technical and scientific terms used herein have the same meanings usually understood by those of ordinary skill in the art. Unless otherwise specified, the units used in the Specification are units specified in the International System of Units (SI), and numerical values and ranges mentioned in the present disclosure should be understood to include systematic errors inevitable in industrial production. Unless otherwise specified, the experimental methods used in the following examples are conventional methods; used materials, reagents, or instruments not specified in terms of manufacturers are commercially available reagents and materials; if specific conditions are not specified in the examples, conventional conditions or conditions recommended by the manufacturers shall prevail; further, the present disclosure does not limit the sources of the raw materials used; and unless specified otherwise, the raw materials used in the present disclosure are ordinary commercially available products in the art.

It should be particularly noted that the raw materials and equipment used in the specific embodiments of the present disclosure are known products obtained by purchasing commercially available products. Processes of preparing modern TCM formulations from TCM compositions of the present disclosure is mature, and conventional methods in the prior art can be referred to for preparing.

### Example 1

In this example, a pre-modified ferrite magnetic powder and a composite permanent magnet material prepared based on the modified ferrite magnetic powder are provided;

### 1.1 Preparation of the Pre-Modified Ferrite Magnetic Powder

the method is as follows:
calcine ferrite magnetic powder at 1100° C. for 6 h, cool same to room temperature, and then grind the ferrite magnetic powder with a ball mill for 7 h; and prepare a chemical modification solution by using the following parts by mass:
1 part of sodium dodecylbenzenesulfonate, 3 parts of aluminum nitrate, 2 parts of zinc nitrate, 5 parts of polyvinyl alcohol, 3 parts of polymethyl methacrylate, 3 parts of a silane coupling agent KH550, and 75 parts of water;
a specific method of using the above chemical modification solution to modify the ground ferrite magnetic powder is as follows:
weigh and mix raw materials in parts by mass, heat an obtained mixture to 80-90° C. under stirring conditions, stir same for 1-2 h at this temperature, cool same to 40-50° C. after a reaction, and adjust a pH value of the solution to 5.

Add the calcined and ground ferrite magnetic powder to the pre-treated chemical modification solution, stir an obtained mixture under nitrogen protection, maintain a reaction at 45° C. for 3-5 h, stir at a speed of 400 rpm to achieve sufficient contact and reaction between the magnetic powder and the solution, where various components in the chemical modification solution can be adsorbed or bonded to surfaces of the ferrite magnetic powder, separate the ferrite magnetic powder after the reaction, wash same with a solvent for many times to remove unreacted coupling agent and impurities, and dry same to obtain the pre-modified ferrite magnetic powder.

### 1.2 Preparation of the Composite Permanent Magnet Material

a specific method of using the above pre-modified ferrite magnetic powder to prepare the composite permanent magnet material is as follows:
the composite permanent magnet material includes the following raw materials in parts by mass:
15 parts of pre-modified ferrite magnetic powder, 60 parts of neodymium-iron-boron (NdFeB) magnetic powder, 3 parts of a coupling agent KH550, 1 part of NDZ-101, 3 parts of a thermoplastic polyurethane elastomer (TPU), 9 parts of a styrene-butadiene-styrene (SBS) block copolymer, 3 parts of nano-silica powder, 0.4 part of benzoyl peroxide, and 1.2 parts of stearic acid.

A preparation method for the composite permanent magnet material includes:
S1: mix the obtain pre-modified ferrite magnetic powder evenly with NdFeB magnetic powder to obtain mixed magnetic powder;
S2: slowly add a coupling agent to the mixed magnetic powder while starting a high-speed mixer, and stir at a speed of 400 rpm for 1.5 h to ensure the coupling agent is uniformly coated on surfaces of particles of the mixed magnetic powder;
S3: pour a resin matrix into the high-speed mixer while stirring at a low speed and adding the mixed magnetic powder coated with the coupling agent to the resin matrix, add a curing agent, and stir at a speed of 600 rpm to obtain a mixed system; and
S4: move the mixed system to an ultrasonic disperser for ultrasound dispersion treatment for 30 min to prepare a magnetic colloid.

### Example 2

In this example, a pre-modified ferrite magnetic powder and a composite permanent magnet material prepared based on the modified ferrite magnetic powder are provided;

### 2.1 Preparation of the Pre-Modified Ferrite Magnetic Powder

The difference from Example 1 lies in that a chemical modification solution is prepared by using the following raw materials in parts by mass:
1 part of sodium dodecylbenzenesulfonate, 5 parts of aluminum nitrate, 5 parts of polyvinyl alcohol, 3 parts of polymethyl methacrylate, 3 parts of a silane coupling agent KH550, and 75 parts of water; and
a method of using the above chemical modification solution to modify the ground ferrite magnetic powder is the same as that specified in Example 1.

### 2.2 Preparation of the Composite Permanent Magnet Material

A method of using the above pre-modified ferrite magnetic powder to prepare the composite permanent magnet material is the same as that specified in Example 1.

### Example 3

In this example, a pre-modified ferrite magnetic powder and a composite permanent magnet material prepared based on the modified ferrite magnetic powder are provided;

### 3.1 Preparation of the Pre-Modified Ferrite Magnetic Powder

The difference from Example 1 lies in that a chemical modification solution is prepared by using the following raw materials in parts by mass:
1 part of sodium dodecylbenzenesulfonate, 5 parts of zinc nitrate, 5 parts of polyvinyl alcohol, 3 parts of polymethyl methacrylate, 3 parts of a silane coupling agent KH550, and 75 parts of water;
a method of using the above chemical modification solution to modify the ground ferrite magnetic powder is the same as that specified in Example 1.

### 3.2 Preparation of the Composite Permanent Magnet Material

A method of using the above pre-modified ferrite magnetic powder to prepare the composite permanent magnet material is the same as that specified in Example 1.

### Example 4

In this example, a pre-modified ferrite magnetic powder and a composite permanent magnet material prepared based on the modified ferrite magnetic powder are provided;

### 4.1 Preparation of the Pre-Modified Ferrite Magnetic Powder

The preparation method, including a composition of a chemical modification solution and a specific modification method, is the same as that specified in Example 1.

### 4.2 Preparation of the Composite Permanent Magnet Material

a specific method of using the above pre-modified ferrite magnetic powder to prepare the composite permanent magnet material is as follows:
Different from that in Example 1, the composite permanent magnet material provided in this example includes the following raw materials in parts by mass:
60 parts of pre-modified ferrite magnetic powder, 15 parts of neodymium-iron-boron (NdFeB) magnetic powder, 4 parts of a coupling agent KH550, 3 parts of a thermoplastic polyurethane elastomer (TPU), 9 parts of a styrene-butadiene-styrene (SBS) block copolymer, 3 parts of nano-silica powder, 0.4 part of benzoyl peroxide, and 1.2 parts of stearic acid.

### Example 5

In this example, a pre-modified ferrite magnetic powder and a composite permanent magnet material prepared based on the modified ferrite magnetic powder are provided;

### 5.1 Preparation of the Pre-Modified Ferrite Magnetic Powder

The preparation method, including a composition of a chemical modification solution and a specific modification method, is the same as that specified in Example 1.

### 5.2 Preparation of the Composite Permanent Magnet Material

a specific method of using the above pre-modified ferrite magnetic powder to prepare the composite permanent magnet material is as follows:
Different from that in Example 1, the composite permanent magnet material provided in this example includes the following raw materials in parts by mass:
60 parts of pre-modified ferrite magnetic powder, 15 parts of neodymium-iron-boron (NdFeB) magnetic powder, 4 parts of a coupling agent NDZ-101, 3 parts of a thermoplastic polyurethane elastomer (TPU), 9 parts of a styrene-butadiene-styrene (SBS) block copolymer, 3 parts of nano-silica powder, 0.4 part of benzoyl peroxide, and 1.2 parts of stearic acid.

### Example 6

In this example, a pre-modified ferrite magnetic powder and a composite permanent magnet material prepared based on the modified ferrite magnetic powder are provided;

### 6.1 Preparation of the Pre-Modified Ferrite Magnetic Powder

The preparation method, including a composition of a chemical modification solution and a specific modification method, is the same as that specified in Example 1.

### 6.2 Preparation of the Composite Permanent Magnet Material

a specific method of using the above pre-modified ferrite magnetic powder to prepare the composite permanent magnet material is as follows:
Different from that in Example 1, the composite permanent magnet material provided in this example includes the following raw materials in parts by mass:
60 parts of pre-modified ferrite magnetic powder, 15 parts of neodymium-iron-boron (NdFeB) magnetic powder, 3 parts of a coupling agent KH550, 1 part of NDZ-101, 1 part of a thermoplastic polyurethane elastomer (TPU), 11 parts of a styrene-butadiene-styrene (SBS) block copolymer, 3 parts of nano-silica powder, 0.4 part of benzoyl peroxide, and 1.2 parts of stearic acid.

A preparation method for the composite permanent magnet material is the same as that specified in Example 1.

### Example 7

In this example, a pre-modified ferrite magnetic powder and a composite permanent magnet material prepared based on the modified ferrite magnetic powder are provided;

### 7.1 Preparation of the Pre-Modified Ferrite Magnetic Powder

The preparation method, including a composition of a chemical modification solution and a specific modification method, is the same as that specified in Example 1.

### 7.2 Preparation of the Composite Permanent Magnet Material

a specific method of using the above pre-modified ferrite magnetic powder to prepare the composite permanent magnet material is as follows:
Different from that in Example 1, the composite permanent magnet material provided in this example includes the following raw materials in parts by mass:
60 parts of pre-modified ferrite magnetic powder, 15 parts of neodymium-iron-boron (NdFeB) magnetic powder, 3 parts of a coupling agent KH550, 1 part of NDZ-101, 5 parts of a thermoplastic polyurethane elastomer (TPU), 7 parts of a styrene-butadiene-styrene (SBS) block copolymer, 3 parts of nano-silica powder, 0.4 part of benzoyl peroxide, and 1.2 parts of stearic acid.

A preparation method for the composite permanent magnet material is the same as that specified in Example 1.

### Comparative Example 1

In this comparative example, a pre-modified ferrite magnetic powder and a composite permanent magnet material prepared based on the pre-modified ferrite magnetic powder are provided, and a preparation method for the modified ferrite magnetic powder is different from that in Example 1, i.e., only calcination and grinding are performed, without any chemical modification.

A preparation method for the composite permanent magnet material is the same as that specified in Example 1.

### Comparative Example 2

In this comparative example, a composite permanent magnet material is provided, including the following components:
75 parts of neodymium-iron-boron (NdFeB) magnetic powder, 3 parts of a coupling agent KH550, 1 part of NDZ-101, 3 parts of a thermoplastic polyurethane elastomer (TPU), 9 parts of a styrene-butadiene-styrene (SBS) block copolymer, 3 parts of nano-silica powder, 0.4 part of benzoyl peroxide, and 1.2 parts of stearic acid.

A preparation method for the composite permanent magnet material is the same as that specified in Example 1.

### Comparative Example 3

In this comparative example, a modified ferrite magnetic powder and a composite permanent magnet material prepared based on the modified ferrite magnetic powder are provided. Regarding calcination and ball milling methods for the modified ferrite magnetic powder, reference may be made to Example 1, and a formulation of a chemical modification solution is as follows:
1 part of sodium dodecylbenzenesulfonate, 3 parts of aluminum nitrate, 2 parts of zinc nitrate, 8 parts of polyvinyl alcohol, 3 parts of a silane coupling agent KH550, and 75 parts of water; and
a preparation method for the composite permanent magnet material is the same as that specified in Example 1.

### Comparative Example 4

In this comparative example, a modified ferrite magnetic powder and a composite permanent magnet material prepared based on the modified ferrite magnetic powder are provided. A preparation method for the modified ferrite magnetic powder is relative to calcination and ball milling methods described in Example 1, and a formulation of a chemical modification solution is as follows:
1 part of sodium dodecylbenzenesulfonate, 3 parts of aluminum nitrate, 2 parts of zinc nitrate, 8 parts of polymethyl methacrylate, 3 parts of a silane coupling agent KH550, and 75 parts of water;
a preparation method for the composite permanent magnet material is the same as that specified in Example 1.

### Experimental Example

In this experimental example, magnet-free magnetic false eyelashes are prepared by using the composite permanent magnet materials obtained in the Examples 1-7 and Comparative Examples 1-4. Specifically, a preparation method therefore includes:

prepare polyethylene filaments (as an eyelash band portion) with an attached simulated hair portion, and the composite permanent magnet materials obtained in Examples 1-7 and Comparative Examples 1-4, coat the polyethylene filaments with the composite permanent magnet material by using a glue coating machine, then cure same, and subsequently magnetize same with a high-pressure magnetizer to produce a highly magnetic filament, so as to obtain the magnet-free magnetic false eyelashes.

The eyelash band portion of the magnet-free magnetic false eyelash is tested as follows:

### (1) Tensile Strength

Testing method: cut a sample of the false eyelash band with a length of 30 mm and a thickness of approximately 0.2 mm, mount same on a clamp of a tensile testing machine, set a tensile speed to 1 mm/min to 2 mm/min, start the tensile testing machine, and record data.

Calculation method: when the false eyelash band is broken, read a maximum tensile force value F (N) from the data recorded in the testing machine. Measure an average width b and an average thickness h of the sample to calculate a cross-sectional area S=b×h (mm²), and
calculate the tensile strength (MPa) according to the formula: tensile strength=F/S.

### (2) Breaking Elongation

Prepare and mount a sample with reference to the method in the foregoing (1), before testing, use a high-precision marker to mark two reference lines on a middle of the sample that are spaced at a predetermined gauge length Lo=20 mm, stretch the sample at a predetermined tensile speed, and monitor variations in a distance between the two reference lines during the stretching.

Calculation method: after the sample is broken, record a final distance Li between the two reference lines, and calculate the breaking elongation according to the following formula:

$$breaking elongation = [ ( {L}_{1} - {L}_{0} ) / {L}_{0} ] \times 100 \% ,$$

$$with the result expressed by percentage ( \% ) .$$

(3) Test coercivity, remanence (Br), and maximum energy product (BH)ₘₐₓ of the sample.
(4) Test the Situation of Magnetic Powder Shedding with Reference to the Method Mentioned in the Specification of the Patent CN102456459B.

Results of performance tests in the foregoing (1) to (4) are shown in Table 1:

TABLE 1
Performance comparison of Examples 1-7 and Comparative Examples 1-4

| | | | | | | Maximum | |
|---|---|---|---|---|---|---|---|
| | Processing | | | | | energy | |
| | performance | Tensile | Breaking | | | product | Magnetic |
| | and band | strength | elongation | | Remanence | (BH)ₘₐₓ | powder |
| Test sample | appearance | (MPa) | (%) | Coercivity | (Br) (T) | (MGOe) | shedding |
| Example 1 | Excellent | 32.1 | 422 | 782 | 0.81 | 31.6 | Excellent |
| Example 2 | Excellent | 27.8 | 315 | 654 | 0.73 | 26.1 | General |
| Example 3 | Excellent | 26.5 | 307 | 689 | 0.68 | 24 | Defective |
| Example 4 | Excellent | 25.6 | 345 | 679 | 0.72 | 25.9 | General |
| Example 5 | Excellent | 27.3 | 285 | 652 | 0.75 | 26.3 | Excellent |
| Example 6 | Excellent | 19.6 | 369 | 703 | 0.73 | 24.3 | General |
| Example 7 | Poor | 30.3 | 406 | 744 | 0.61 | 26.2 | General |
| Comparative | Excellent | 15.2 | 235 | 412 | 0.44 | 15.6 | Defective |
| Example 1 | | | | | | | |
| Comparative | Excellent | 21.2 | 348 | 1214 | 1.13 | 42.6 | Excellent |
| Example 2 | | | | | | | |
| Comparative | Excellent | 28.1 | 364 | 579 | 0.66 | 21.3 | Excellent |
| Example 3 | | | | | | | |
| Comparative | Excellent | 26.1 | 397 | 647 | 0.60 | 23.5 | Defective |
| Example 4 | | | | | | | |

The above experimental examples show that Example 1 exhibits the optimal performance. Although Comparative Example 2 is superior to Example 1 in some performance aspects, costs are higher and parameters of mechanical properties such as the tensile strength and the breaking elongation are inferior to those of comparative examples. Therefore, the method provided in Example 1 is preferred for industrial application.

### (5) Softness Testing of the Bands:

Under room temperature conditions, five testers with beauty makeup experience bend the bands of the test samples into different arcs, and feel resistance, elasticity and recovery situations of the bands during bending, specifically including: observe whether the bands are easily broken during bending, whether they can quickly return to original shapes, or whether they retain a bent state.

Evaluation method: based on the testers' feelings, softness and wearing comfort, scores are given according to the following criteria:
1-2 points: very hard, difficult to bend, and extremely uncomfortable to wear;
3-4 points: relatively hard, noticeable resistance when bending, and some foreign body sensation during wearing;
5-6 points: moderate in softness, not too difficult to bend, and generally comfortable to wear;
7-8 points: relatively soft, easy to bend, and relatively comfortable to wear;
9-10 points: extremely soft, almost resistance-free, and excellent in contact with skin;
The five testers score independently, and record an average score, with experimental results shown in Table 2.

TABLE 2
Performance comparison of Examples 1-7 and Comparative
Examples 1-4 in softness and wearing comfort

| | Tester | Tester | Tester | Tester | Tester | Average |
|---|---|---|---|---|---|---|
| Test sample | 1 | 2 | 3 | 4 | 5 | score |
| Example 1 | 10 | 10 | 10 | 9 | 10 | 9.8 |
| Example 2 | 8 | 8 | 8 | 9 | 9 | 8.4 |
| Example 3 | 10 | 9 | 9 | 8 | 9 | 9 |
| Example 4 | 8 | 7 | 7 | 8 | 8 | 7.6 |
| Example 5 | 8 | 7 | 8 | 8 | 9 | 8 |
| Example 6 | 7 | 8 | 8 | 7 | 6 | 7.2 |
| Example 7 | 5 | 4 | 4 | 4 | 6 | 4.6 |
| Comparative | 5 | 6 | 5 | 4 | 5 | 5 |
| Example 1 | | | | | | |
| Comparative | 8 | 9 | 9 | 7 | 8 | 8.2 |
| Example 2 | | | | | | |
| Comparative | 8 | 8 | 9 | 8 | 8 | 8.2 |
| Example 3 | | | | | | |
| Comparative | 9 | 8 | 7 | 7 | 8 | 7.8 |
| Example 4 | | | | | | |

The above experimental examples show that Example 1 exhibits the optimal performance in softness and wearing comfort, followed by Example 3. In contrast, false eyelash bands made in other examples and comparative examples are significantly inferior in comfort.

It should be particularly noted that the above embodiments are merely intended for describing the technical solutions of the present disclosure rather than limiting same. Although the present disclosure is described in detail with reference to the above embodiments, persons of ordinary skill in the art should understand that they may still make modifications or equivalent replacements to the technical solutions of the present disclosure without departing from the spirit and scope of the technical solutions of the present disclosure, which shall fall within the scope of the claims of the present disclosure. The technologies, shapes and structures not described in detail in the present disclosure are prior arts.

1. A composite permanent magnet material, comprising the following raw materials in parts by mass: 15-25 parts of pre-modified ferrite magnetic powder, 50-75 parts of neodymium-iron-boron (NdFeB) magnetic powder, 1-5 parts of a coupling agent, 8-12 parts of a resin matrix, 3-5 parts of a filling agent, 0.1-0.5 part of a curing agent, and 0.8-1.4 parts of a lubricant.

2. The composite permanent magnet material according to claim 1, wherein the coupling agent is any one of a silane coupling agent or a titanate coupling agent, wherein the silane coupling agent is any one or a combination of KH550 and KH560, and the titanate coupling agent is any one or a combination of NDZ-101 and NDZ-201;
the filling agent is selected from any one or more of silica powder, silicon nitride powder, aluminum silicate powder, calcium silicate powder, calcium carbonate powder, and barium sulfate powder;
the curing agent is any one or a combination of benzoyl peroxide and dibutyltin dilaurate; and
the lubricant is any one or more of magnesium stearate, zinc stearate, stearic acid, or paraffin.

3. The composite permanent magnet material according to claim 1, wherein the resin matrix is a mixture of any one or more of styrene-butadiene rubber (SBR), a thermoplastic polyurethane elastomer (TPU), a styrene-butadiene-styrene (SBS) block copolymer, and epoxy resin.

4. A preparation method for the composite permanent magnet material according to claim 1, comprising the following steps:
S1: modifying ferrite magnetic powder as a raw material to prepare pre-modified ferrite magnetic powder; and mixing the pre-modified ferrite magnetic powder evenly with NdFeB magnetic powder to obtain mixed magnetic powder;
S2: slowly adding a coupling agent to the mixed magnetic powder while starting a high-speed mixer, and stirring at a speed of 300-500 rpm for 1-2 h to ensure the coupling agent is uniformly coated on surfaces of particles of the mixed magnetic powder;
S3: pouring a resin matrix into the high-speed mixer while stirring at a low speed and adding the mixed magnetic powder coated with the coupling agent to the resin matrix, adding a curing agent, and stirring at a speed of 300-800 rpm to obtain a mixed system; and
S4: moving the mixed system to an ultrasonic disperser for ultrasound dispersion treatment for 10-50 min to prepare a magnetic colloid.

5. The preparation method according to claim 4, further comprising the step of curing the obtained magnetic colloid.

6. The preparation method according to claim 4, further comprising the step of thermocuring or photocuring the obtained magnetic colloid.

7. The preparation method according to claim 4, wherein a preparation method for the pre-modified ferrite magnetic powder comprises:
calcining ferrite magnetic powder at 1000-1100° C. for 4-6 h, cooling same to room temperature, then grinding the ferrite magnetic powder with a ball mill for 6-8 h, and modifying same with a chemical modification solution, where the chemical modification solution includes at least an alkyl coupling agent; and
the chemical modification solution includes the following raw materials in parts by mass: 0.5-2 parts of sodium dodecylbenzenesulfonate, 2-5 parts of aluminum nitrate, 1-3 parts of zinc nitrate, 2-6 parts of polyvinyl alcohol, 2-4 parts of polymethyl methacrylate, 2-5 parts of a silane coupling agent, and 70-80 parts of water.

8. An application of the composite permanent magnet material in cosmetics and beauty products according to claim 1.

9. The application according to claim 8, wherein the application is an application of preparing a magnet-free magnetic false eyelash, and the magnet-free magnetic false eyelash comprises at least one magnetic-inductive component and a simulated hair portion attached to the magnetic-inductive component, wherein the magnetic-inductive component is partially or entirely made from the composite permanent magnet material.
